(19) United States
(12) Patent Application Publication
(10) Pub. No.: US 2013/0252051 A1
(43) Pub. Date: Sep. 26, 2013

(54) BATTERY SYSTEM

(71) Applicants: Yasuaki Hiramura, Tokyo (JP); Akira Takeyama, Tokyo (JP)

(72) Inventors: Yasuaki Hiramura, Tokyo (JP); Akira Takeyama, Tokyo (JP)

(73) Assignee: MITSUBISHI HEAVY INDUSTRIES, LTD., Tokyo (JP)

(21) Appl. No.: 13/876,190

(22) PCT Filed: Aug. 1, 2011
(86) PCT No.: PCT/JP2011/067624

§ 371 Date: Jun. 10, 2013

(30) Foreign Application Priority Data
Sep. 30, 2010 (JP) 2010-222497

(51) Int. Cl. H01M 10/48

(52) U.S. Cl. CPC H01M 10/482
USPC 429/92; 429/90

(57) ABSTRACT

A battery system including: a secondary battery (7A) including a stacked electrode body housed in a battery can (11A), a positive electrode terminal and the battery can (11A) being electrically connected; a secondary battery (7B) including a stacked electrode body housed in a battery can (11B), a positive electrode terminal and the battery can (11B) being electrically connected; a cell can voltage sensor (9A) that measures a first voltage of the battery can (11A); a cell can voltage sensor (9B) that measures a second voltage of the battery can (11B); and a BMU (15) that receives information corresponding to the measured first and second voltages of the cell can voltage sensors (9A, 9B). The BMU (15) activates expansion detection information based on the information when the first voltage increases and the second voltage decreases substantially simultaneously with the increase, thereby enabling detection of presence or absence of expansion.

### TECHNICAL FIELD

The present invention relates to a battery system including an assembled battery.

### BACKGROUND ART

Secondary batteries are typically classified into two types of a wound type and a stacked type. Each type of the secondary batteries has a configuration (hereinafter referred to as a stacked electrode body) in which electrode plates (a positive electrode plate and a negative electrode plate) are stacked through a separator serving as an insulator. The wound-type secondary battery has a configuration in which one sheet-like positive electrode plate and one sheet-like negative electrode plate are stacked through a separator and are rolled up and housed in a battery container. The stacked-type secondary battery has a configuration in which a plurality of sheet-like positive electrode plates and a plurality of sheet-like negative electrode plates are sequentially stacked through a separator and are housed in a battery container without being rolled up. The battery container includes members such as a container body having an opening, and a cover that covers the opening. After the stacked electrode body is housed in the container body, the opening is covered by the cover, thereby sealing the battery container.

The secondary battery is capable of repeatedly charging and discharging. However, when charging and discharging are repeatedly carried out, the battery container may expand due to the expansion of an internal electrode plate, decomposition of an electrolyte, or the like. The expansion of the battery container may lead to an occurrence of a failure of the secondary battery. For this reason, it is necessary to detect the expansion at an appropriate time to prevent occurrence of a failure of the secondary battery.

In this regard, a battery system and the like have been developed in which special equipment such as a press button switch or a strain detector is provided on the surface of a secondary battery and the special equipment is brought into press contact with adjacent secondary batteries, thereby detecting the expansion (see PTL 1 and PTL 2).

### CITATION LIST

### Patent Literature

### {PTL 1}

Japanese Unexamined Patent Application, Publication No. Hei 06-52901

### {PTL 2}

PCT International Publication No. WO 2002/099922

### SUMMARY OF INVENTION

### Technical Problem

However, when special equipment such as a press button switch or a strain detector for detecting an expansion of a battery container as disclosed in PTL 1 and PTL 2 is newly provided in the battery container, a dedicated circuit or the like is required, which complicates the configuration and leads to an increase in cost.

The present invention has been made in view of the above-mentioned circumstances, and an object of the present invention is to provide a battery system capable of easily detecting an expansion of a battery container of a secondary battery that constitutes an assembled battery with a simple configuration without an increase in cost.

### Solution to Problem

To solve the above-mentioned problem, a battery system according to a first aspect of the present invention includes: a first secondary battery including a stacked electrode body connected to a first electrode terminal and a second electrode terminal, the stacked electrode body being housed in a first battery can, the first electrode terminal and the first battery can being electrically connected through a first conductive path; a second secondary battery including a stacked electrode body connected to a third electrode terminal and a fourth electrode terminal, the stacked electrode body being housed in a second battery can, the third electrode terminal and the second battery can being electrically connected through a second conductive path; a first battery can voltage sensor that measures a first voltage of the first battery can; a second battery can voltage sensor that measures a second voltage of the second battery can; and a control device that receives information corresponding to the measured first and second voltages of the first and second battery can voltage sensors. The control device activates expansion detection information based on the information when the first voltage increases and the second voltage decreases substantially simultaneously with the increase.

According to the configuration described above, the control device can easily recognize a contact or the like between battery cans due to an expansion of a battery can, when the expansion detection information is active, by using the information corresponding to the voltage measured by the first and second battery can voltage sensors which are respectively arranged in the first and second battery cans. This eliminates the need to provide special equipment such as a press button switch or a strain detector to the battery can.

### Advantageous Effects of Invention

According to the present invention, it is possible to provide a battery system capable of easily detecting an expansion of a battery container of a secondary battery that constitutes an assembled battery with a simple configuration without an increase in cost.

### BRIEF DESCRIPTION OF DRAWINGS

FIG. 1 is a block diagram illustrating a configuration of a battery system according to an embodiment of the present invention.

FIG. 1 is a breakaway view of a secondary battery used for a battery system according to an embodiment of the present invention.

FIG. 3 is a diagram illustrating an array of each secondary battery in the battery system according to an embodiment of the present invention.

FIG. 4A is a schematic view illustrating an electric circuit obtained after battery cans of adjacent two secondary batteries among a plurality of arrayed secondary batteries contact each other.

FIG. 4B is an electric circuit diagram obtained after battery cans of adjacent two secondary batteries among a plurality of arrayed secondary batteries contact each other.

FIG. 5 is a schematic diagram illustrating an electric circuit obtained after battery cans of adjacent three secondary batteries among a plurality of arrayed secondary batteries contact each other.

### DESCRIPTION OF EMBODIMENTS

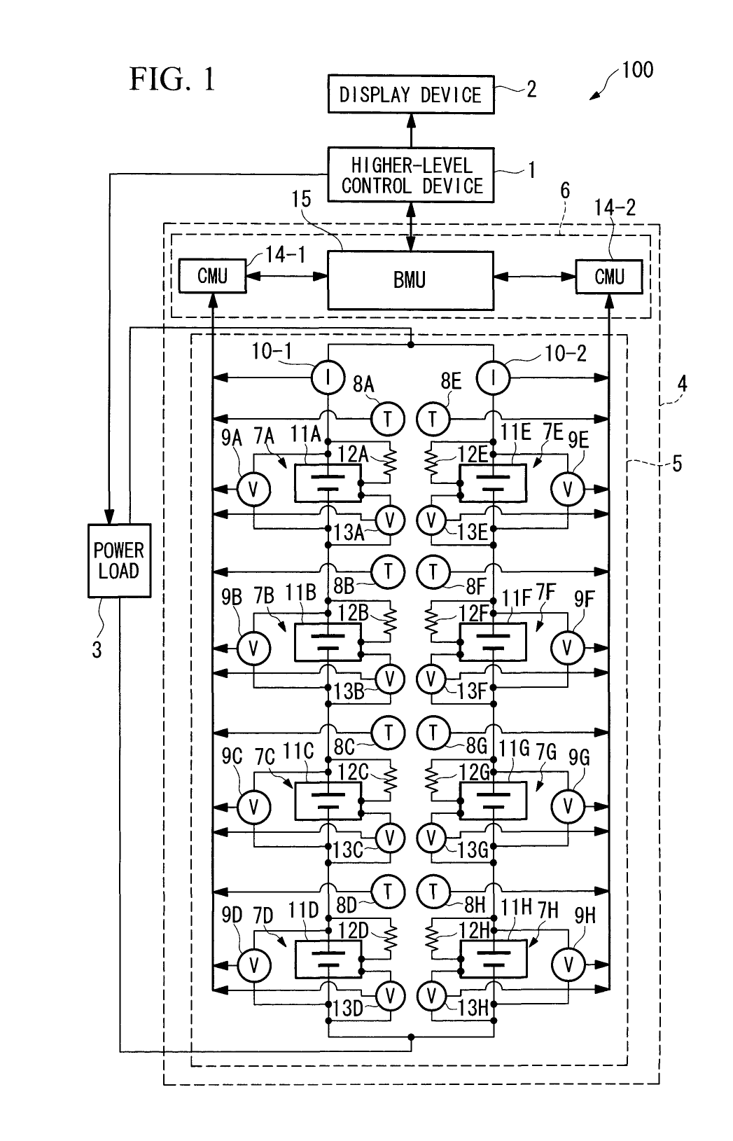

An embodiment of a battery system according to the present invention will be described below with reference to the drawings. FIG. 1 is a block diagram illustrating a configuration of a battery system 100 according to this embodiment.

The battery system 100 according to this embodiment includes a higher-level control device 1, a display device 2, a power load 3, and a battery module 4. The battery module 4 is formed of an assembled battery 5 and a BMS (Battery Management System) 6. The battery module 4 has a form of a module which is easily replaced from the outside of the battery system 100. The higher-level control device 1, the display device 2, and the power load 3 are incorporated in the battery system 100 in advance. In this case, a combination of the higher-level control device 1 and a BMS 6 is also referred to simply as a control device.

The battery system 100 according to the present invention may be an industrial vehicle such as a forklift having wheels connected to an electric motor serving as the power load 3, a moving body such as a electric car or an electric vehicle, or a moving body such as an airplane or a ship with a propeller or a screw connected to an electric motor serving as the power load 3. Alternatively, the battery system 100 may be a power storage system for domestic use, a stationary system such as a power grid stabilization system in combination with power generation by natural energy such as a windmill or sunlight, for example. That is, the battery system 100 is a system that utilizes charging and discharging of power by a plurality of secondary batteries that constitute an assembled battery.

The assembled battery 5 within the battery module 4 supplies power to the power load 3 of the battery system 100, and has a configuration in which an arm (first arm) composed of secondary batteries 7A to 7D, which are connected in series, and an arm (second arm) composed of secondary batteries 7E to 7H, which are connected in series, are connected in parallel.

In the secondary batteries 7A to 7H that constitute the assembled battery 5, temperature sensors 8A to 8H that measure the container temperature (battery can temperature) of each secondary battery and cell voltage sensors 9A to 9H that measure the inter-terminal voltage (voltage between the positive electrode terminal and the negative electrode terminal of each secondary battery) are arranged so as to respectively correspond to the secondary batteries. Each arm includes a corresponding current sensor 10-1 and a corresponding current sensor 10-2, thereby enabling measurement of a current flowing through each arm.

Further, in the battery system 100, the battery container is a battery can made of conductive metal such as aluminium. Examples of the battery container that houses the stacked electrode body include a battery container made of plastic and a battery container made of metal. In the case of using a battery can, the electrolyte encapsulated in the battery can together with the stacked electrode body described above reacts with the inner wall of the battery can, which may modify the battery can or deteriorate the performance of the battery. For example, in the case of a lithium ion secondary battery using a battery can made of an aluminum-based material, pull-up resistors 12A to 12H having a high resistance (about 1 kΩ or more) and electrically connecting the positive electrode terminals, which are provided to secondary batteries 7A to 7H as described later, with battery cans 11A to 11H respectively corresponding to the positive electrode terminals, are provided to respective secondary batteries 7A to 7H, so as to avoid the failure occurring due to the reaction between the inner walls of the battery cans 11A to 11H and the electrolyte encapsulated in the battery cans. Since these pull-up resistors form a conductive path, the voltage of each battery can is substantially the same as the voltage of the positive electrode terminal. To check the connections of the pull-up resistors 12A to 12H, battery can voltage sensors 13A to 13H that measure the battery can voltage of each secondary battery (voltage between the negative electrode terminal and the battery can of each secondary battery) are arranged so as to respectively correspond to the secondary batteries.

Although not illustrated, in a similar manner, in the case of a lithium ion secondary battery using a battery can made of an iron-based material (including an iron alloy), for example, pull-down resistors having a high resistance (about lkQ or more) and electrically connecting negative electrode terminals, which are provided to secondary batteries, with battery cans respectively corresponding to the negative electrode terminals are arranged so as to respectively correspond to the secondary batteries. Since these pull-down resistors form a conductive path, the voltage of each battery can is substantially the same as the voltage of each negative electrode terminal. To check the connections of the pull-down resistors, battery can voltage sensors that measure the battery can voltage (voltage between the positive electrode terminal and the battery can of each secondary battery) of each secondary battery are arranged so as to respectively correspond to the secondary batteries.

The battery can voltage sensor may be a so-called voltmeter, a comparator indicating that the can voltage is equal to or higher than a reference voltage or equal to or lower than the reference voltage, or the like.

Since a battery can is used as the battery container, an insulating sheet made of plastic, for example, is disposed between the stacked electrode body and the inner wall of the battery can so as to prevent an electrical contact between the stacked electrode body and the inner wall of the battery can.

The measurement information (battery can temperature, current values of each arm, and values of inter-terminal voltages of each secondary battery (inter-terminal voltage value) and information corresponding to a value (battery can voltage value) of a battery can voltage), which are measured by various sensors and output, are input to the BMS 6.

Specifically, the measurement information of each of the temperature sensors 8A to 8D, cell voltage sensors 9A to 9D, and battery can voltage sensors 13A to 13D, which are arranged so as to respectively correspond to the secondary batteries 7A to 7D constituting the first arm, and the current sensor 10-1 arranged to correspond to the first arm is input to a CMU 14-1 which is arranged in the BMS 6 so as to correspond to the first arm through a bus. Similarly, the measurement information of each of the temperature sensors 8E to 8H, cell voltage sensors 9E to 9H, and battery can voltage sensors 13E to 13H, which are arranged so as to respectively correspond to the secondary batteries 7E to 7H constituting the second arm, and the current sensor 10-2 arranged so as to correspond to the second arm is input to a CMU 14-2 which is arranged in the BMS 6 so as to correspond to the second arm through a bus.

The measurement information input to each of the CMU 14-1 and CMU 14-2 is output from these CMU at an appropriate time and input to the BMU 15.

In the BMU 15 having received the measurement information described above, the related information such as the information corresponding to the measurement information, information on a charging rate (SOC) of each secondary battery, which is calculated within the BMU 15 by using the measurement information, or expansion detection information (described later) is transmitted to the higher-level control device 1 at an appropriate time.

The higher-level control device 1 controls the power load 3 according to an instruction of a user or an operator (for example, the amount by which an accelerator pedal is depressed by a user), receives the related information transmitted from the BMS 6, and controls the display device 2 to cause the display device 2 to display the related information as needed. When determining that the related information indicates an abnormal value, the higher-level control device 1 causes an abnormality lamp incorporated in the display device 2 to light, for example, and activates an acoustic device such as a buzzer or the like incorporated in the display device 2 to issue an alarm, thereby stimulating a sense of vision and a sense of hearing by light and sound to attract attention of a user.

The display device 2 is a monitor, such as a liquid crystal panel, including the acoustic device, and is capable of displaying the related information of the secondary batteries 7A to 7H constituting the assembled battery 5 based on the control from the higher-level control device 1, for example.

The power load 3 is an electric power converter such as an electric motor or an inverter connected to wheels of an electric vehicle, for example. The power load 3 may be an electric motor that drives a wiper or the like.

In this case, the assembled battery 5 has a configuration in which four secondary batteries are connected in series to form one arm, and two arms in total are connected in parallel. However, the number of secondary batteries to be connected to each arm and the number of arms are arbitrarily designed as long as at least two secondary batteries are provided. As described later, this is because at least two secondary batteries using a battery can are required to detect an expansion of the battery can in the battery system 100.

Referring next to FIG. 2, the outline of the configuration of each of the secondary batteries 7A to 7H will be described. Since these secondary batteries have the same configuration, the secondary batteries are simply denoted by reference numeral “7”, and reference symbols “A” to “H” are omitted. Similarly, identical secondary batteries are used as the temperature sensors 8A to 8H, cell voltage sensors 9A to 9H, battery can voltage sensors 13A to 13H, and pull-up resistors 12A to 12H, which are arranged so as to correspond to the secondary batteries 7A to 7H, and the battery cans 11A to 11H of the secondary batteries 7A to 7H. Accordingly, FIG. 2 illustrates that each battery can and each pull-up resistor are denoted by reference numerals “11” and “12”, respectively, and reference symbols “A” to “H” are omitted.

The secondary battery 7 is a secondary battery including a stacked electrode body in which electrode plates (a positive electrode plate and a negative electrode plate) are stacked through a separator serving as a porous insulator. In this case, a stacked type lithium ion secondary battery incorporating a battery can having a square shape (square-shaped) with dimension H×dimension L×dimension W and having sides on X, Y, and Z axes which are perpendicular to each other is illustrated (where H>0, L>0, W>0).

In this case, a square battery can 11 is formed of an aluminium-based material (for example, A3000 system). On one surface (corresponding to a cover) of the battery can 11, a positive electrode terminal 17 and a negative electrode terminal 18 are arranged in the state of penetrating through the corresponding battery can 11. Note that an insulator 16 is arranged between the positive electrode terminal 17, the negative electrode terminal 18, and the battery can 11 such that the positive electrode terminal 17 and the negative electrode terminal 18 are not in electrically contact with the battery can 11. Further, on the one surface of the battery can 11, a safety valve 22 that is self-destroyed by a pressure having a certain value or greater in case the internal pressure (inner pressure) of the battery can 11 increases due to generation of a gas within the battery can 11. Furthermore, a pull-up resistor 12 is connected between the positive electrode terminal 17 and the battery can 11, and the voltage of the battery can 11 is substantially the same as the voltage of the positive electrode terminal 17.

The battery can 11 houses a stacked electrode body in which a positive electrode plate 20 having lithium manganate (LiMn₂O₄) as an active material, for example, and a negative electrode plate 21 having carbon as an active material, for example, are sequentially stacked through a separator 19. An insulating sheet (not illustrated) is arranged between the stacked electrode body and the battery can 11 such that the stacked electrode body does not contact the wall surface of the battery can 11.

A predetermined amount of electrolyte (not illustrated) is injected into the battery can 11. The positive electrode plate 20 is connected to the positive electrode terminal 17 within the battery can 11, and the negative electrode plate 21 is connected to the negative electrode terminal 18 is connected within the battery can 11.

Note that the battery can 11 is hermetically and airtightly sealed in the state where the stacked electrode body and the electrolyte are contained therein.

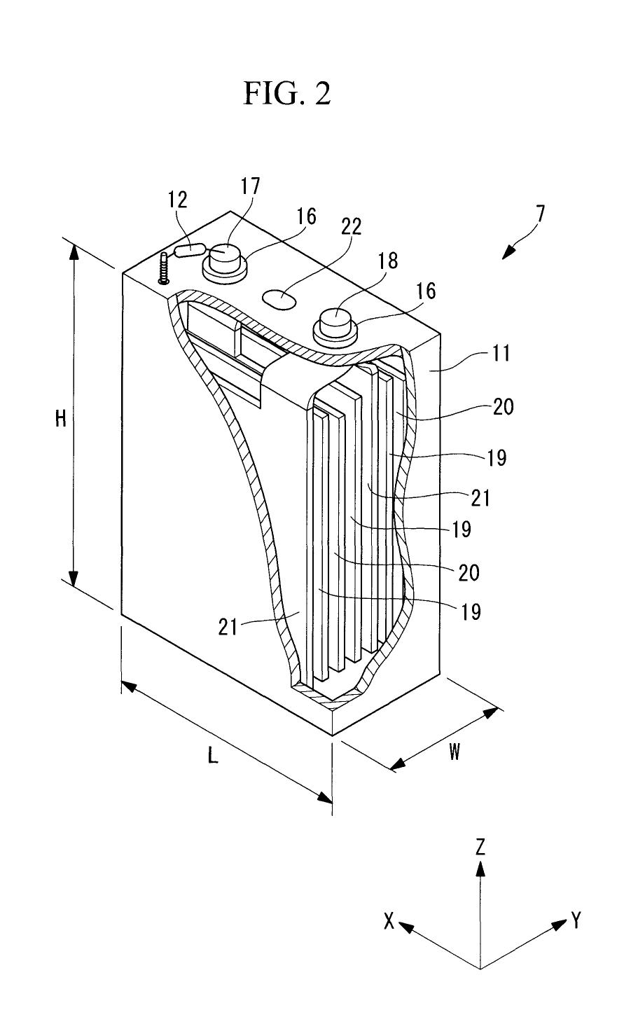

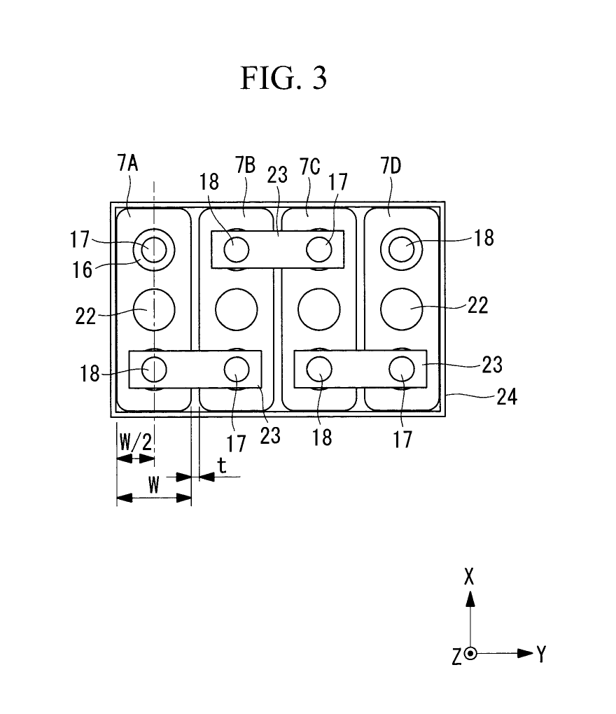

Next, FIG. 3 illustrates an array configuration of a plurality of secondary batteries constituting one arm. In this case, the configuration in which the secondary batteries 7A to 7D constitute the first arm is illustrated as a typical example. This is an arrangement on an XY-plane when viewed from one surface on which the electrode terminals (the positive electrode terminal 17 and the negative electrode terminal 18) of the secondary battery 7 illustrated in FIG. 2 are formed. Note that in FIG. 3, the illustration of each of the pull-up resistor 12, the temperature sensors 8A to 8D, the cell voltage sensors 9A to 9D, and the battery can voltage sensors 13A to 13D of each secondary battery is omitted.

If the battery can 11 expands, the degree of the deformation is largest in the vicinity of the center of one surface (a surface having a largest area among the surfaces of the battery can 11, i.e., a surface having dimension L×dimension H) of the battery can 11 on the xz-plane of the secondary battery 7 arranged as illustrated in FIG. 2. Accordingly, the one surfaces are aligned and arranged at an interval by a width t (where t>0) so as to face the adjacent secondary battery.

The electrode terminals of the secondary batteries 7A to 7D are physically connected as needed in series by a bus bar 23. The bus bar 23 is fixed to the electrode terminal with a screw (not illustrated), so that the arranged relative positions of the secondary batteries 7A to 7D are fixed by the bus bar 23 and are housed in the container 24. The dimension of the inner wall of the container 24 is substantially dimension L×(dimension 4 W+dimension 3 t)×dimension H.

As described above, the relative positions of the secondary batteries 7A to 7D are fixed by the bus bar 23. However, when a gas is generated in the battery can 11 and the inner pressure increases, for example, the vicinity of the center expands and deforms to contact the adjacently arranged battery can 11 of the secondary battery. The detection of the expansion of the battery can in the battery system according to the present invention utilizes the contact.

Accordingly, the dimension of the width t is appropriately designed so that a width W of the battery can 11 can be deformed into a width (W+2 t) due to the expansion before the inner voltage at which the safety valve 22 is destroyed is reached.

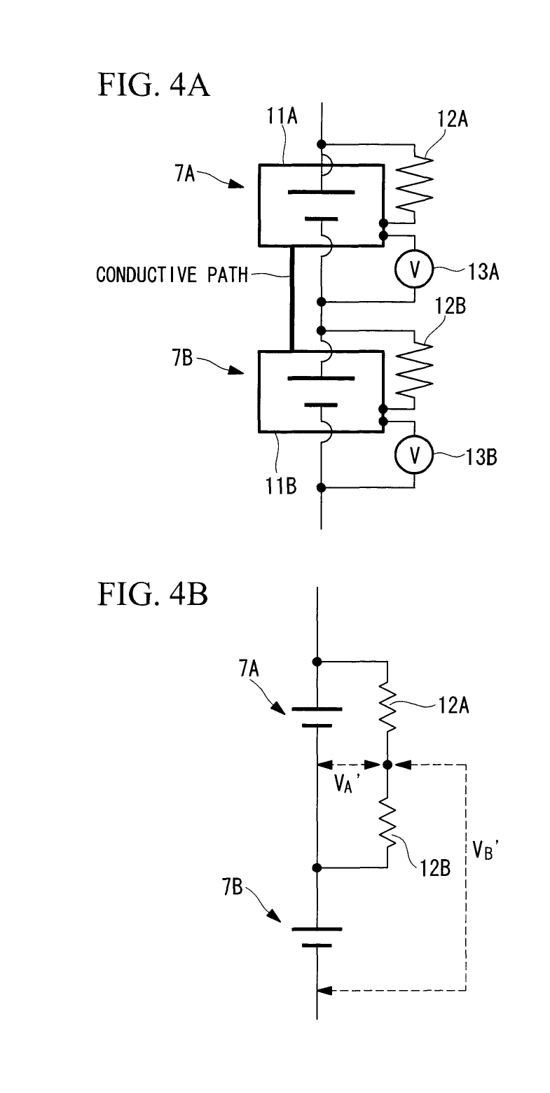

Now, the detection of the expansion of the battery can 11 in the battery system 100 will be described in detail below. FIG. 4 is a diagram illustrating the case where in the secondary batteries 7A to 7D arranged in the container 24 as illustrated in FIG. 3, the inner voltage of the battery can 11A of the secondary battery 7A increases, for example, so that the battery can 11A expands and contacts the battery can 11B of the adjacent secondary battery 7B. When the secondary battery 7A expands, one surface of the battery can 11A along the XZ-plane can expand so as to contact the battery can 11B of the secondary battery 7B, but the expansion of the other surface is inhibited by the inner wall of the container 24. That is, FIG. 4 is a typical explanatory diagram in the case where the battery cans 11 of the two adjacent secondary batteries 7 contact each other (the case where the battery cans 11 of three secondary batteries 7 contact each other will be described later).

As illustrated in FIG. 4A, when the battery can 11A expands and contacts the battery can 11B, a conductive path is generated between these two battery cans. In this configuration, as illustrated in an electric circuit diagram of FIG. 4B, the pull-up resistor 12A and the pull-up resistor 12B are connected in series between the positive electrode terminal and the negative electrode terminal of the secondary battery 7A and the positive electrode terminal of the secondary battery 7B is connected to the negative electrode of the secondary battery 7B.

Accordingly, assuming that the voltage value measured by the battery can voltage sensor 13A prior to the contact is V_{A}; the voltage value measured by the battery can voltage sensor 13B prior to the contact is V_{B}; the resistance value of the pull-up resistor 12A is R_{A}; the resistance value of the pull-up resistor 12B is R_{B}; the voltage value measured by the battery can voltage sensor 13A after the contact is V_{A}′; and the voltage value measured by the battery can voltage sensor 13B prior to the contact is V_{B}′, V_{A}′ and V_{B}′ are expressed by the following formulas (1) and (2).

$$\begin{matrix}{V}_{A}^{′} = \frac{{R}_{B}}{{R}_{A} + {R}_{B}} {V}_{A} & ( 1 ) \\ {V}_{B}^{′} = \frac{{R}_{B}}{{R}_{A} + {R}_{B}} {V}_{A} + {V}_{B} & ( 2 )\end{matrix}$$

where in consideration that V_{A} and V_{B} are substantially the same voltage value Vp, and R_{A} and R_{B} are substantially the same resistance value R, the voltage values V_{A}=V_{B}=Vp obtained prior to the contact change into V_{A}=(½)Vp and V_{B}=( 3/2)Vp after the contact.

Specifically, assuming that the inter-terminal voltage of the positive electrode terminal 17 and the negative electrode terminal 18 of the secondary battery 7 is 4 V, the battery can voltage of the secondary batteries whose battery cans 11 are not in contact with each other among the second batteries connected in series in a certain arm is 4 V. Meanwhile, the battery can voltage of one of the two secondary batteries whose battery cans 11 contact each other is 2 V, and the battery can voltage of the other secondary battery is 6 V.

Accordingly, in the BMU 15 that receives the measurement information, when one of the pieces of measurement information which are input from the CMU 14-1 corresponding to the first arm and correspond to the battery can voltage sensors 13A to 13D decreases to the corresponding value from Vp to (½)Vp and the other one increases simultaneously (substantially simultaneously) with the decrease to the corresponding value from Vp to ( 3/2)Vp, the battery cans 11 of the two secondary batteries 7 corresponding to the battery can voltage sensors within the first arm that output these values are determined to be in contact with each other. In the example of FIG. 4, a contact between the battery cans of the secondary batteries 7A and 7B within the first arm is specified.

Then, after the specification, the BMU 15 transmits expansion detection information as the related information to the higher-level control device 1. Examples of the expansion detection information may include information indicating the presence or absence of expansion of a battery can (for example, active or “1” when an expansion is present, and inactive or “0” when an expansion is absent).

Having received expansion detection information (for example, when the expansion detection information indicates “1”) indicating that the battery can expands, the higher-level control device 1 controls display device 2 to cause the abnormality lamp described above to light, for example, and activates the acoustic device such as a buzzer incorporated in the display device 2 to issue an alarm, thereby allowing the user or operator to recognize the abnormality of the battery system 100 and to move the battery system 100 to a safe place, for example, to promote an inspection/repair. In this case, the display device 2 is allowed to display an abnormality by causing the abnormality lamp to light, for example, or activating the acoustic device.

As a matter of course, when a battery can expansion lamp is provided to the display device 2 separately from the abnormality lamp and the higher-level control device 1 receives the expansion detection information (for example, when the expansion detection information indicates “1”), the higher-level control device 1 may control the display device 2 to cause the battery can expansion lamp to light, for example, and may activate an acoustic device such as a buzzer incorporated in the display device 2 to issue an alarm. Further, the related information described above also includes information on the can voltage value of each secondary battery 7. Accordingly, in the case where the higher-level control device 1 controls the display device 2, it is also possible to allow the display device 2 to display which of the secondary batteries 7 is specified.

Note that in the determination, measurement information on voltage values which are input to the BMU 15 and measured by the cell voltage sensors 9 arranged respectively to correspond to the secondary batteries 7 may also be used. The example will be described in detail below.

The example illustrates the case where the battery cans 11A and 11B contact each other. The voltage values of the cell voltage sensors 9A and 9B prior to the contact are approximately Vp. Thus, at this time, each value obtained by subtracting a voltage measured by each battery can voltage sensor from a voltage measured by each cell voltage sensor is about 0. After these two battery cans contact each other, the values change into V_{A}=(½)Vp and V_{B}=( 3/2)Vp as described above. Accordingly, values obtained by subtracting voltages measured by each battery can voltage sensor from voltages measured by each cell voltage sensor are (½)Vp and (−½)Vp, respectively. That is, in the BMU 15, differences between the pieces of measurement information of these two sensors arranged in the corresponding secondary battery are obtained using the measurement information which is input from the CMU 14-1 corresponding to the first arm and corresponds to the cell voltage sensors 9A to 13D and battery can voltage sensors 13A to 13D. When one of the differences decreases to the corresponding value from about 0 to (−½)Vp and when the other difference increases simultaneously (substantially simultaneously) with the decrease to the corresponding value from about 0 to (½)Vp, the battery cans 11 of the two secondary batteries 7 within the first arm corresponding to these values are determined to be in contact with each other. In the example of FIG. 4, it is specified that the battery cans of the second batteries 7A and 7B within the first arm contact each other.

As described above, the circuit diagram of FIG. 4 illustrates the case where the battery can 11A expands and contacts the battery can 11B of the adjacent secondary battery 7B. In the secondary battery on both sides of which the secondary batteries 7 are arranged, when the expansion of the battery can 11 is not uniform and only one of the two surfaces of the battery can 11 along the xz-plane first contacts the battery can 11 of the adjacent secondary battery 7, the same circuit diagram may also be used. For example, in the case where the battery can 11B of the secondary battery 7B expands and, if the surface on the side of the secondary battery 7A first contacts the battery can 11A, rather than the surface on the side of the secondary battery 7C of the two surfaces of the battery can 11B along the xz-plane does, the same circuit as that illustrated in FIG. 4 can be used. Also in this case, the operation of the BMS 6 including the BMU 15, and the operation of the higher-level control device 1 are same as those described above.

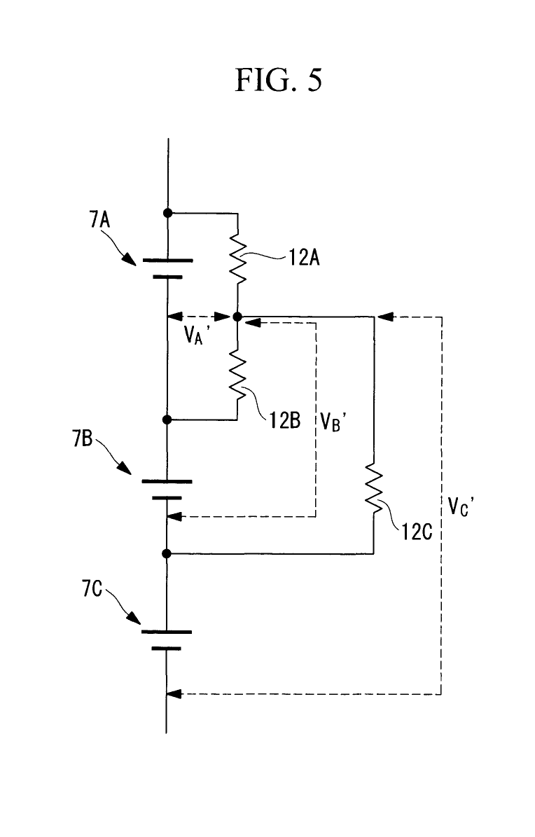

Note that in the secondary battery on both sides of which the secondary batteries 7 are arranged within one arm, when the battery can 11 expands uniformly and two surfaces of the battery can 11 along the xz-plane contact substantially simultaneously with the battery cans 11 of the secondary batteries 7 on both sides, the circuit diagram illustrated in FIG. 5 is obtained. FIG. 5 is a diagram illustrating a circuit in which in the secondary batteries 7A to 7D arranged within the container 24 as illustrated in FIG. 3, the inner voltage of the battery can 11B of the secondary battery 7B increases, for example, so that the battery can 11B expands and contacts the battery can 11A of the secondary battery 7A and the battery can 11C of the secondary battery 7C, which are adjacently arranged, simultaneously (substantially simultaneously). The pull-up resistor 12A and the pull-up resistor 12B are connected in series between the positive electrode terminal and the negative electrode terminal of the secondary battery 7A; the pull-up resistor 12B and the pull-up resistor 12C are connected in series between the positive electrode terminal and the negative electrode terminal of the secondary battery 7B; and the negative electrode terminal of the secondary battery 7B is connected to the positive electrode terminal of the secondary battery 7C.

Assuming herein that the voltage value measured by the battery can voltage sensor 13C prior to the contact is V_{C}; the resistance value of the pull-up resistor 12C is Rc; and the voltage value measured by the battery can voltage sensor 13C after the contact is V_{C}′, V_{B}′ and V_{C}′ are expressed by the following formulas (3) and (4). V_{A}′ is the same as the formula (1) described above.

$$\begin{matrix}{V}_{B}^{′} = \frac{{R}_{C}}{{R}_{B} + {R}_{C}} {V}_{B} & ( 3 ) \\ {V}_{C}^{′} = \frac{{R}_{C}}{{R}_{B} + {R}_{C}} {V}_{B} + {V}_{C} & ( 4 )\end{matrix}$$

where in consideration that each of V_{A}, V_{B}, and V_{C} represents substantially the same voltage value Vp and each of R_{A}, R_{B}, and R_{C} represents substantially the resistance value R, the voltage values V_{A}=V_{B}=V_{C}=Vp obtained prior to the contact simultaneously (substantially simultaneously) change into V_{A}=(½) Vp, V_{B}=(½) Vp, and V_{C}=( 3/2) Vp after the contact.

Specifically, assuming that the inter-terminal voltage of the positive electrode terminal 17 and the negative electrode terminal 18 of the secondary battery 7 is 4 V, the battery can voltage of the secondary batteries whose battery cans 11 are not in contact with each other among the secondary batteries connected in series in a certain arm is 4 V. Meanwhile, the battery can voltages of three secondary batteries whose battery cans 11 contact each other are 2 V, 2 V, and 6 V, respectively.

Accordingly, in the BMU 15 that receives measurement information, when arbitrary two of the pieces of measurement information which are input from the CMU 14-1 corresponding to the first arm and correspond to the battery can voltage sensors 13A to 13D decrease to the corresponding value from Vp to (½)Vp and when any one of the information increases simultaneously (substantially simultaneously) with the decrease to the corresponding value from Vp to ( 3/2)Vp, it is determined that the battery cans 11 of the three secondary batteries 7 corresponding to the battery can voltage sensors within the first arm that output these values contact each other. In the example of FIG. 4, it is specified that the battery cans of the secondary batteries 7A, 7B, and 7C within the first arm contact each other.

After the specification, the BMU 15 transmits expansion detection information as the related information to the higher-level control device 1, as in the case where the battery cans 11 of the two secondary batteries 7 contact each other as described above. The subsequent operation in the higher-level control device 1 is similar to that described above.

In the control device of the battery system 100 described above, i.e., in the higher-level control device 1 and the BMS 6, as described above, the secondary batteries 7 whose battery cans 11 contact each other can be specified based only on a change in the measurement information of the battery can voltage sensors 13A to 13H, or on a change in the difference between the two pieces of measurement information of the battery can voltage sensors 13A to 13H and the cell voltage sensors 9A to 13H. Further, the display device 2 is allowed to display which of the secondary batteries 7 within the battery system 100 are the secondary batteries 7 specified as being in contact with each other. Note that in the battery system 100, the BMU 15 transmits the expansion detection information as the related information to the higher-level control device 1. This expansion detection information is activated (or “1”) when a conductive path is generated between two battery cans due to short-circuiting or the like, for example. Accordingly, the expansion detection information is activated not only when each battery can expands, but also when the conductive path is generated due to adhesion of a conductor such as a metal scrap to the two battery cans, for example. In the case of adhesion of the conductor, for example, it is effective that the user or the like is notified of an abnormality, though it is not due to an expansion of a battery can, to thereby promote the inspection, repair, or the like.

However, when the measurement information on the battery can temperatures of the temperature sensors 8A to 8H is also taken into consideration, it is possible to specify the plurality of contacting secondary batteries 7, and it is also possible to specify that the cause is an expansion involving heat generation and to specify the expanding secondary batteries 7.

Specifically, in the case of an expansion involving heat generation of the battery can 11, it can be specified that the secondary battery 7 corresponding to the temperature sensor that measures a high temperature that is greatly different from the temperature of another secondary battery 7 (for example, a high temperature with a temperature difference of 10° C. or more) among the contacting secondary batteries 7 surely expands.

Accordingly, the control device performs control such that the secondary battery 7, which is specified as surely expanding, is displayed in a different manner (for example, the secondary battery 7 whose contact is specified are displayed with different display and color) upon display of the secondary battery 7 whose contact is specified, for example, thereby allowing the user or operator to recognize the secondary battery 7 that has surely expanded. This facilitates the inspection/repair.

Although the present invention has been described above with reference to the embodiments, the technical scope of the present invention is not limited to the scope of the embodiments. The embodiments described above can be changed or modified in various manners without departing from the gist of the invention.

For example, in the battery system of the embodiment described above, square battery cans are used in a plurality of secondary batteries 7, but the battery cans may have any shape. For example, a cylindrical-shape battery can may also be used. The shape of each battery can is not limited to a can shape. As long as the battery can is a conductive battery container, the battery can may include a laminated battery container.

A stacked type has been described above as the stacked electrode body, but any type may be employed. That is, a wound type, a button type, or a coin type may be employed.

Furthermore, the battery can voltage sensor 13 measures the voltage of the battery can 11 with respect to the negative electrode terminal 16 of the corresponding secondary battery 7, but may measure the voltage of the battery can 11 with respect to the positive electrode terminal 17 of the corresponding secondary battery 7.

### REFERENCE SIGNS LIST

1 HIGHER-LEVEL CONTROL DEVICE
2 DISPLAY DEVICE
3 POWER LOAD
4 BATTERY MODULE
5 ASSEMBLED BATTERY
6 BMS
7 SECONDARY BATTERY
8 TEMPERATURE SENSOR
9 CELL VOLTAGE SENSOR
10-1, 10-2 CURRENT SENSOR
11 BATTERY CAN
12 PULL-UP RESISTOR
13 BATTERY CAN VOLTAGE SENSOR
14-1, 14-2 CMU
15 BMU
16 INSULATOR
17 POSITIVE ELECTRODE TERMINAL
18 NEGATIVE ELECTRODE TERMINAL
19 SEPARATOR
20 POSITIVE ELECTRODE PLATE
21 NEGATIVE ELECTRODE PLATE
22 SAFETY VALVE
23 BUS BAR
24 CONTAINER

1. A battery system comprising:
a first secondary battery including a stacked electrode body connected to a first electrode terminal and a second electrode terminal, the stacked electrode body being housed in a first battery can, the first electrode terminal and the first battery can being electrically connected through a first conductive path;
a second secondary battery including a stacked electrode body connected to a third electrode terminal and a fourth electrode terminal, the stacked electrode body being housed in a second battery can, the third electrode terminal and the second battery can being electrically connected through a second conductive path;
a first battery can voltage sensor that measures a first voltage of the first battery can;
a second battery can voltage sensor that measures a second voltage of the second battery can; and
a control device that receives information corresponding to the measured first and second voltages of the first and second battery can voltage sensors,
wherein the control device activates expansion detection information based on the information when the first voltage increases and the second voltage decreases substantially simultaneously with the increase.

2. The battery system according to claim 1, wherein
the first and third electrode terminals are positive electrode terminals,
the second and fourth electrode terminals are negative electrode terminals, and
the first and second conductive paths are formed of a pull-up resistor.

3. The battery system according to claim 1, wherein
the first and third electrode terminals are negative electrode terminals,
the second and fourth electrode terminals are positive electrode terminals, and
the first and second conductive paths are formed of a pull-down resistor.

4. The battery system according to claim 1, further comprising:
a first temperature sensor that measures a first temperature of the first battery can and outputs information corresponding to the first temperature to the control device; and
a second temperature sensor that measures a second temperature of the second battery can and outputs information corresponding to the second temperature to the control device,
wherein the control device determines that the first or second battery can in which the first or second temperature sensor that outputs information corresponding to a higher one of the first temperature and the second temperature has expanded.

5. The battery system according to claim 4, further comprising a display device, wherein
the control device causes the display device to perform an abnormal display when the expansion detection information is active.
